(19) United States
(12) Patent Application Publication
(10) Pub. No.: US 2026/0163229 A1
(43) Pub. Date: Jun. 11, 2026

(54) BASE STATION ANTENNAS WITH RADIATING ELEMENTS PROVIDED BY A NONMETALLIC SUBSTRATE HAVING METAL SURFACES THEREON

(71) Applicant: Outdoor Wireless Network LLC, Claremont, NC (US)

(72) Inventors: Fan He, Suzhou (CN); Ligang Wu, Suzhou (CN); Zhanming Zhang, Suzhou (CN); Fusheng Lv, Suzhou (CN); YongJie Xu, Suzhou (CN); Giuseppe Resnati, Seregno, Monza e Brianza (IT)

(21) Appl. No.: 18/707,746

(22) PCT Filed: Oct. 20, 2022
(86) PCT No.: PCT/US2022/078400

§ 371 Date: May 6, 2024

(30) Foreign Application Priority Data
Dec. 21, 2021 (IT) 102021000031961

(51) Int. Cl. H01Q 1/24; H01Q 1/52; H01Q 9/04; H01Q 19/10; H01Q 21/06; H01Q 21/29

(52) U.S. Cl. CPC H01Q 1/246; H01Q 1/523; H01Q 9/0435; H01Q 19/104; H01Q 21/065; H01Q 21/29

(57) ABSTRACT

Base station antennas are provided that include radiating elements provided by a nonmetallic substrate having metal surfaces thereon. The radiating elements may be provided by a molded body that includes an integrated or cooperating fence grid also of a non-metallic substrate with metal surfaces. A plurality of filter units can be coupled to the molded bodies to define a ground plane without requiring a separate reflector in the base station antenna.

### BACKGROUND

The present invention generally relates to radio communications and, more particularly, to base station antennas for cellular communications systems.

Cellular communications systems are well known in the art. In a cellular communications system, a geographic area is divided into a series of regions or “cells” that are served by respective macrocell base stations. Each macrocell base station may include one or more base station antennas that are configured to provide two-way radio frequency (“RF”) communications with subscribers that are within the cell served by the base station. In many cases, each base station is divided into “sectors.” In one common configuration, a hexagonally-shaped cell is divided into three 120° sectors in the azimuth plane, and each sector is served by one or more macrocell base station antennas that have an azimuth Half Power Beamwidth (HPBW) of approximately 65°. So-called small cell base stations may be used to provide service in high-traffic areas within portions of a cell. Typically, the base station antennas are mounted on a tower or other raised structure, with the radiation patterns that are generated by the base station antennas directed outwardly.

Referring to FIG. 1A, and 1B, as is well known, macrocell base station antennas 10 can comprise one or more linear arrays 11 of radiating elements 11e that are mounted on a reflector assembly 15. The reflector assembly 15 serves as a ground plane for the radiating elements 11e and may also reflect RF energy that is emitted rearwardly by the radiating elements 11e back in the forward direction. The base station antennas 10 can also include a metal fence grid 20 of vertical fence walls 20v and horizontal fence walls 20h that cross each other and define a fence grid. The vertical fence walls 20v are fixed onto the reflector 15r of the reflector assembly by rivets 21 and the horizontal fence walls 20 h are fixed onto the vertical fence walls 20v by rivets 22. The assembly and riveting operation(s) can be time consuming and labor intensive.

### SUMMARY

Pursuant to embodiments of the invention, base station antennas are provided that include at least one body with three-dimensional structures that are attached and formed of a nonmetallic substrate with metal on one or more surfaces of the non-metallic substrate that provide an array of radiating antenna elements.

The base station antenna can also include a fence grid with fence units whereby one fence unit extends about one of the radiating elements. The fence grid and the radiating elements can both include a nonmetallic substrate and metal on one or more surfaces of the non-metallic substrate.

The fence grid can be integral with the body providing the array of radiating elements of a separate cooperating member(s).

The array of radiating elements can be provided by a plurality of injection molded bodies comprising a plurality of radiating elements with arms connecting adjacent radiating elements.

The array of radiating elements can be provided as patch radiating elements.

A filter unit can be coupled to the molded bodies and/or fence grid, optionally via right and left side walls that extend in a front to back direction behind the fence grid.

In some embodiments, the metal layer is electroplated to form outer surfaces of the fence grid, outer surfaces of the radiating elements, and traces extending from the radiating elements to feed columns and/or outer surfaces of the feed columns.

Some aspects are directed to a base station antenna that includes a plurality of radiating elements. Each radiating element has a non-metallic substrate and metal on defined surfaces of the non-metallic substrate. The base station antenna also includes a fence grid comprising a plurality of fence units. One fence unit has a pair of horizontal walls and a pair of vertical walls that extend about one radiating element of the plurality of radiating elements.

The base station antenna can also include a longitudinally and/or laterally extending arm extending between a pair of adjacent radiating elements of the plurality of radiating elements.

The fence grid can have a non-metallic substrate and metal on at least one outer surface thereof.

The base station antenna can include a longitudinally or laterally extending arm extending between a pair of adjacent radiating elements, and a laterally extending or longitudinally extending arm extending between a vertical and/or horizontal wall of the fence unit extending about respective radiating elements of the pair of adjacent radiating elements.

The plurality of radiating elements can be provided as an antenna module comprising a hollow non-metallic body with a rectangular perimeter that provides a subset of radiating elements of a linear array of radiating elements.

The radiating elements can have a front primary surface that is planar and an opposing rear primary surface. The front primary surface can be metallized and the rear primary surface can have a metallized pattern that can include a plurality of spaced apart metallized regions.

The base station antenna can include a plurality of feed columns that can extend in a rearward direction behind the rear primary surface and that can have a non-metal substrate with an outer surface with metal thereon.

The radiating elements can be provided as patch radiating elements. The plurality of spaced apart metallized regions can be provided as four spaced apart regions, optionally with a remainder of the rear surface being non-metallized. The plurality of feed columns can be provided as four feed columns for providing respective RF signal paths, one feed column being electrically coupled to a corresponding one metallized region.

The plurality of radiating elements can be provided as a first plurality of radiating elements and the base station antenna can also include a second plurality of radiating elements. The first and second plurality of radiating elements can be provided as separate first and second antenna modules with the first antenna module defined by a first body and the second antenna module defined by a second body. The first and second bodies can be formed of the non-metallic substrate. The first and second bodies can be arranged to define at least a portion of a first linear array of radiating elements.

The first body can have a first fence grid segment integral thereto or attached thereto and can include a plurality of fence units forming part of the fence grid. The second body can have a second fence grid segment integral thereto or attached thereto and can include a plurality of fence units forming part of the fence grid.

The first and second bodies can be injection molded with electroplated surfaces forming metal surfaces of the radiating elements.

The plurality of radiating elements and the fence grid can be provided as a unitary body. The unitary body can further include laterally and longitudinally extending arms that extend between vertical and/or horizontal walls of the fence grid and adjacent radiating elements. Either the laterally extending arms can have a greater length than the longitudinally extending arms or the longitudinally extending arms can have a greater length than the laterally extending arms.

Corners of a rear surface of the first and second unitary bodies can have apertures for receiving fasteners.

The base station antenna can also include a printed circuit board residing behind the feed columns that extend in a rearward direction. The printed circuit board can be configured to define a feed network that is coupled to the feed columns.

The base station antenna can also include a filter unit behind the plurality of radiating elements, coupled to a body of an antenna module providing the plurality of radiating elements. The body of the antenna module can provide the plurality of radiating elements as a subset of a linear array of radiating elements or a single linear array of radiating elements of the base station antenna.

The plurality of radiating elements can be a first plurality of radiating elements provided by a first antenna module. The base station antenna can have a second plurality of radiating elements provided by a second antenna module. The filter unit is a first filter unit and the base statin antenna can include a second filter unit. The first filter unit can reside behind the first antenna module and the second filter unit can reside behind the second antenna module.

The fence grid can have a first fence grid segment with a plurality of fence units and a second fence grid segment with a plurality of fence units. Each of the first and second grid segments can have an outer perimeter with rearwardly extending fastener segments. The fastener segments of the first fence grid segment can attach to the first filter unit and the fastener segments of the second fence grid segment can attach to the second filter unit.

The fastener segments can have rearwardly extending legs that cooperate with projections of the filter unit to thereby attach without requiring rivets or screws.

The first filter unit and the second filter unit can be adjacently positioned and can be capacitively coupled.

Each of the first and second filter units can have a cavity with an elongate printed circuit board residing in front of the cavity that can define a cover for the cavity and to provide a ground plane.

Each of the first and second filter units can have a cavity with a metal cover residing in front of the cavity and defining a ground plane.

The base station antenna can also include a radio module behind and coupled to the filter unit.

The first fence grid segment can be provided by a first body and the second fence grid segment can be provided by a second separate body. Outer fence walls of the first and second bodies can be capacitively coupled.

The filter unit can have metal side walls that can electrically couple to the fence grid.

The first and second filter units can be devoid of a front metal cover and can be configured so that a ground plane on a back side of a respective feed board directly contacts a front surface of a corresponding filter unit.

Still other embodiments are directed to a base station antenna that includes: a plurality of filter units that are arranged in columns and rows; and a plurality of antenna modules, each including one or more linear arrays of radiating elements, coupled to and arranged in front of the plurality of filter units.

The filter units can define a ground plane for the plurality of linear arrays of radiating elements and can act as a reflector for the linear arrays of radiating elements.

Adjacent filter units can be capacitively coupled.

The filter units can each have a filter body with a cavity. The filter units can be devoid of a front metal cover and are configured so that a ground plane on a back side of a respective feed board positioned behind subsets of the radiating elements of the linear arrays of radiating elements directly contacts a front surface of a corresponding filter unit.

The filter units can each have a metal front cover that cooperate to define a ground plane for the linear arrays of radiating elements.

The filter units can each have a filter body with a cavity. A rear of the filter units can have coupling members that extend rearwardly and that are configured for attaching to radio modules.

The antenna modules can be provided by a plurality of unitary bodies of a non-metallic substrate formed with surfaces that are metallized to define radiating surfaces.

The base station antenna can also include a fence grid facing a front of the base station antenna and positioned about the linear arrays of radiating elements. The fence grid can be provided by a non-metallic substrate with metal outer surfaces.

The fence grid and the linear arrays of radiating elements can be provided by a plurality of separate bodies of a non-metallic substrate with metallized surfaces, with the separate bodies arranged in columns and row. Each of the plurality of separate bodies can include a subset of the linear arrays of radiating elements and horizontal wall segments and vertical wall segments of the fence grid.

A plurality of the filter units can reside in a first column behind one column of the separate bodies.

The plurality of filter units and the plurality of separate bodies can be provided in equal numbers.

Yet other embodiments are directed to a base station antenna that includes a plurality of antenna modules that are adjacently positioned and spaced apart in columns and rows or columns or rows across a width and a longitudinal length of the base station antenna. Each of the plurality of antenna modules can have a body formed of a non-metallic substrate that provides a plurality of spaced apart planar members at a front thereof. Each of the planar members have a primary front surface and an opposing primary rear surface defining radiating elements. The front surface has a metal outer surface (the metal can extend continuously across at least 70%, typically an entire, outer front surface) and the rear surface has a metallized pattern on only a portion thereof.

The body can be a hollow body with an open back and front side exposing the planar members.

The body can have a rectangular outer perimeter.

The body can also have a plurality of rearwardly extending columns extending from the primary rear surface.

### BRIEF DESCRIPTION OF THE DRAWINGS

FIG. 1A is a front perspective front of a portion of a prior art base station antenna.

FIG. 1B is a greatly enlarged top, right-side portion of the base station antenna shown in FIG. 1A.

FIG. 2 is a front perspective view of a portion of a base station antenna according to embodiments of the present invention.

FIG. 3A is a greatly enlarged top, right-side portion of the base station antenna shown in FIG. 2 according to some embodiments of the invention.

FIG. 3B is a front view of the top, right-side portion of the base station antenna shown in FIG. 3A.

FIG. 4A is a front perspective view of an antenna module forming a part of the base station antenna of FIG. 2 according to embodiments of the present invention.

FIG. 4B is a rear, perspective view of the antenna module shown in FIG. 4A.

FIGS. 5A-5F are front perspective views of different example antenna module configurations according to embodiments of the present invention.

FIGS. 6A-6C are front perspective views of different configurations of the radiating elements of an example antenna module according to embodiments of the present invention.

FIG. 7A is a front perspective view of an example fence grid according to embodiments of the present invention.

FIG. 7B is a greatly enlarged rear perspective view of an example radiating element according to embodiments of the present invention.

FIG. 8A is a front perspective view of a portion of a prior art base station antenna similar to that shown in FIG. 1A.

FIG. 8B is an enlarged rear, side perspective view of a portion of the base station antenna shown in FIG. 1B illustrating a filter unit attached thereto.

FIG. 9 is a front, side perspective view of a portion of a base station antenna according to embodiments of the present invention.

FIG. 10 is a front, side perspective view of a filter and antenna assembly module shown in the base station antenna of FIG. 9 according to further embodiments.

FIGS. 11 and 12 are front, side perspective views of filter and antenna assembly modules according to further embodiments of the present invention.

FIG. 13A is an enlarged, partial exploded, front perspective view of a filter unit according to further embodiments.

FIG. 13B is an assembled view of FIG. 13A.

FIG. 13C is a partial section view taken along line 13C-13C in FIG. 13B.

FIG. 14 is an enlarged, partial front view of an antenna and filter assembly module coupled to a radio module according to embodiments of the present invention.

FIG. 15 is an enlarged, end perspective view with a partial section view taken along line 15-15 of FIG. 14.

FIG. 16A is an enlarged side perspective view of the antenna and filter assembly module and radio module shown in FIG. 14 according to embodiments of the present invention.

FIG. 16B is a longitudinal section view taken along line 16B-16B in FIG. 16A.

### DETAILED DESCRIPTION

The demand for cellular communications capacity has been increasing at a high rate. As a result, the number of base station antennas has proliferated in recent years.

Base station antennas are both relatively large and heavy and, as noted above, are typically mounted on antenna towers. Due to the wind loading on the antennas and the weight of the antennas and associated radios, cabling and the like, antenna towers must be built to support significant loads. This increases the cost of the antenna towers.

Pursuant to embodiments of the present invention, base station antennas are provided that include antenna modules provided as at least one three-dimensional body providing an array (or sub-array) of radiating elements. These antenna modules are formed of a non-conductive substrate with one or more metal surfaces. The three-dimensional body can be attached to a fence grid or fence grid segment that is a separate component or integral to the three-dimensional body and can also be provided by a non-conductive substrate with metal surfaces. The three-dimensional body providing the array of radiating elements can reduce assembly time and labor and the number of fasteners required.

Pursuant to further embodiments of the present invention, base station antennas are provided that include a bank of filter units, arranged in columns and rows, that cooperate with the antenna modules to provide a ground plane without requiring a separate reflector in the base station antenna which can reduce costs and/or weight. The ground plane can be provided by a plurality of cooperating metal surfaces provided by the filter units and/or by a ground plane of printed circuit boards defining covers of the filter units and residing behind the radiating elements. These and other features and inventive concepts will be discussed below.

In the description that follows, base station antennas and the components thereof are described using terms that assume that the base station antennas are mounted for use on a tower with the longitudinal axis of the antenna extending along a vertical (or near vertical) axis and the front surface of the antenna mounted opposite the tower or other mounting structure pointing toward the coverage area for the antenna.

Embodiments of the present invention will now be discussed in greater detail with reference to the attached figures.

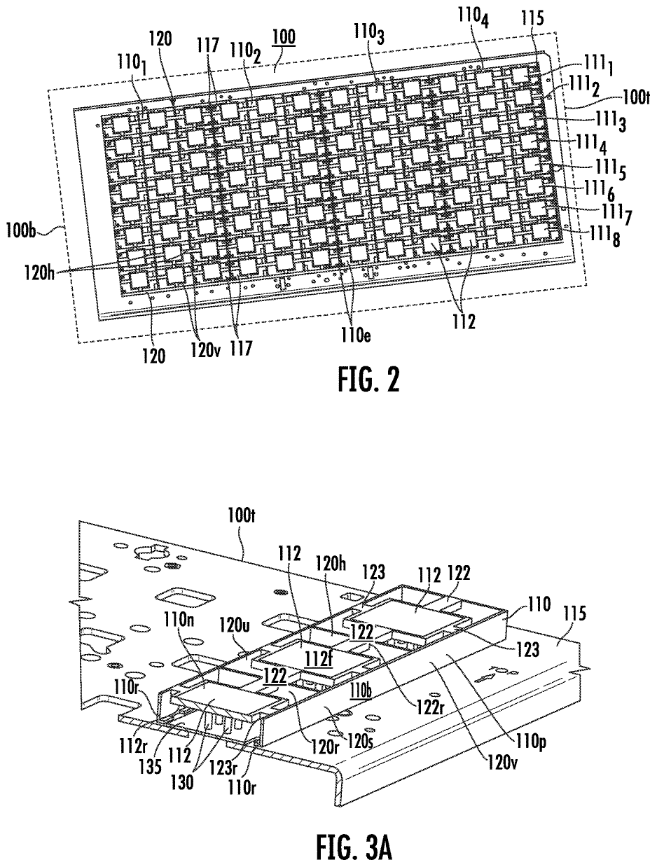

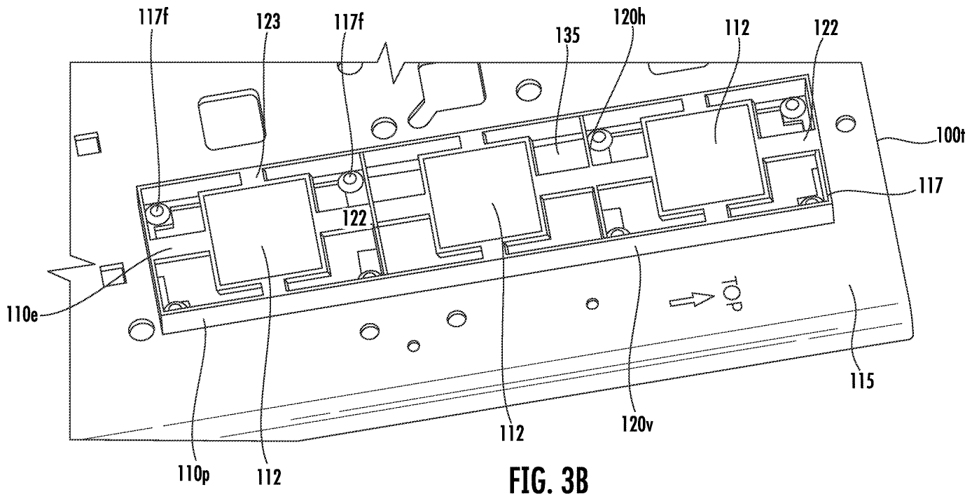

With reference to FIGS. 2, 3A, 3B, a base station antenna 100 according to some embodiments is shown. The base station antenna 100 includes a plurality of linear arrays 111 of radiating elements 112 arranged in a plurality of laterally spaced apart and adjacent longitudinally extending columns between a top 100t and a bottom 100b of the base station antenna 100. In the example embodiment, there are eight columns 111₁-111₈ of linear arrays 111 of radiating elements 112. The radome 100 is shown schematically in FIG. 2 (in broken line about an outer perimeter of the radiating elements 112).

The linear arrays 111 of radiating elements can be configured as massive Multiple Input, Multiple Output (mMIMO) arrays.

The radiating elements 112 can be configured as patch radiating elements in some embodiments.

The linear arrays 111 can be inside a base station antenna housing and may define part or all of a passive antenna assembly (and the linear arrays 111 may provide components of the passive antenna assembly) and/or may define all or part of an active antenna assembly. Alternatively, the linear arrays 11 may be provided in an active antenna module that couples to a rear of the base station antenna housing. The arrays 111 of radiating elements 112 may form a mMIMO array of radiating elements in some embodiments. For further details regarding example active antenna modules and base station antenna housings with passive antenna assemblies, see, co-pending U.S. patent application Ser. No. 17/209,562 and corresponding PCT Patent Application Serial Number PCT/US 2021/023617, the contents of which are hereby incorporated by reference as if recited in full herein.

Still referring to FIGS. 2, 3A, 3B, as shown, in some embodiments, the base station antenna 100 can include a reflector 115 and a fence grid 120. The fence grid 120 can include fence units 120u. Each fence unit 120u can have pairs of horizontal walls 120h and pairs of vertical walls 120v extending about a respective radiating element 112. Adjacent fence units 120u can share a horizontal wall 120h or a vertical wall 120v.

As also shown, the base station antenna 100 includes a plurality of antenna modules 110. Each antenna module 110 comprises a plurality of radiating elements 112. A plurality of the antenna modules 110 can be arranged to define entire columns or parts of columns and/or parts of rows of the linear arrays 111 of radiating elements 112.

The antenna module 110 can have a three-dimensional body 110b of structures formed of a non-metallic substrate with one or more metal surfaces 110m thereon configured to provide a plurality of the radiating elements 112. The body 110b can be a hollow body with an open back side and front side exposing the structures providing the radiating elements 112 and feed columns 130. The body 110b can have a rectangular perimeter 110p surrounding the structures providing the radiating elements 112. The radiating elements 112 can be planar and have a front primary surface 112f and an opposing rear primary surface 112r. The radiating elements 112 can merge into a plurality of feed columns 130 that can extend rearward behind the rear primary surface 112r and couple to a printed circuit board 135 (which can also be interchangeably referred to as a “feed board”). The feed columns 130 can be integral to respective radiating elements 112 and also be formed of the non-metallic substrate 110 and comprise metal 110m on an outer surface thereof.

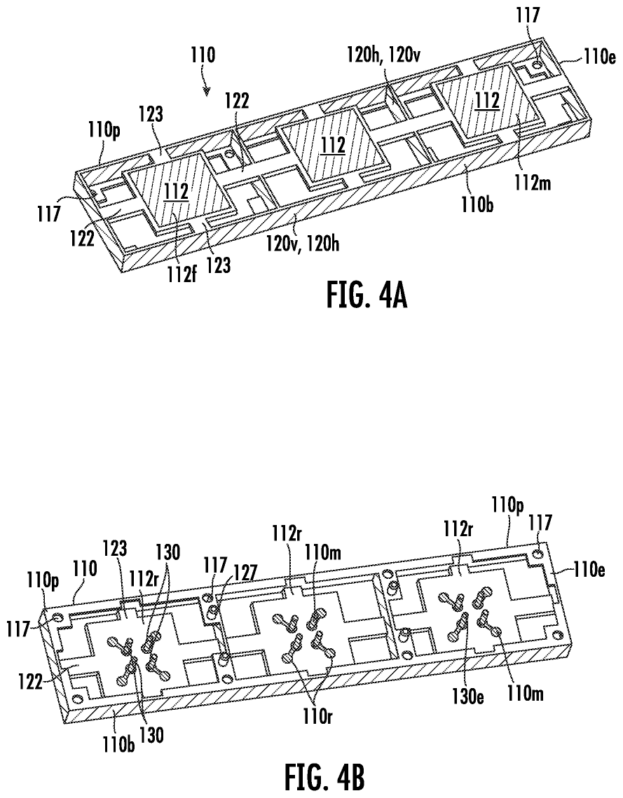

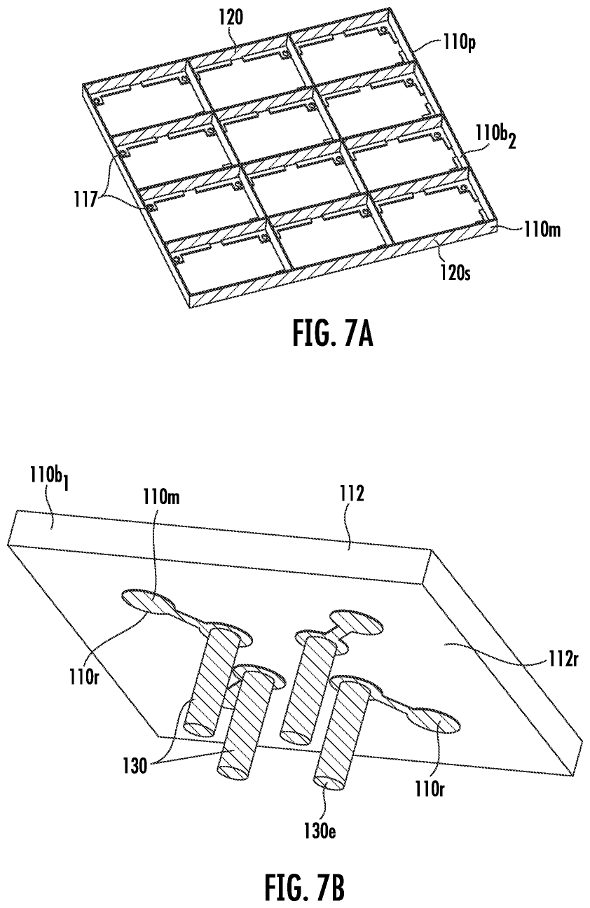

Referring to FIGS. 4A, 4B, 7A, 7B, as shown by the shading/cross-hatching on certain structures and features, the metal 110m can be provided on at least one side of each vertical and horizontal wall 120v, 120v, the front primary surface 112f of the radiating elements, the feed columns 130, including the inner ends 130e of the columns and a pattern of spaced apart regions 110r on a rear primary surface 112r of the radiating elements 112.

The remainder of the structures provided by the body 110 b or bodies 110b1, 110b 2 of a respective antenna module 110 can be defined by the non-metallic substrate and can be devoid of any metal.

The metal 110m can comprise aluminum or an aluminum alloy. In some embodiments, the metal 110m can comprise one or more of copper, aluminum, silver, tin, nickel, or combinations or alloys thereof.

In some embodiments, the metal 110m comprises a metal having an electrical conductivity in the range of from about 9×10⁶ to 6.3×10⁷ siemens per meter (S/m).

The metal 110m may be formed and/or secured to the non-metallic substrate using any suitable technique. In some embodiments, the non-metallic substrate is preformed, e.g., injection molded, and the metal is thereafter applied. Suitable methods for applying the metal to the non-metallic substrate may include coating the substrate with the metal 110m, for example, by spraying, dipping, painting, (electro) plating, and flooding. Suitable methods for applying the metal 110m to the body 110 b of the antenna module 110 formed by the non-metallic substrate may also include laminating the metal onto the substrate. In some embodiments, the metal 110m can be co-laminated, coextruded, or co-molded (e.g., insert molded or thermoformed) with the substrate. Different surfaces of the body 110b of the antenna module 110 may have different metal and the different metal may be provided in different manners. In some embodiments, a common metal can be applied to all surfaces that are desired to be metallized and the common metal can be provided in a common thickness or different thicknesses, on average.

The antenna module 110 can have first and second arms 122 that extend off opposing sides of, and between, adjacent radiating elements 112. The arms 122 can extend across (or to) a horizontal or vertical wall 120h, 120v. The antenna module 110 can have third and fourth arms 123 that extend off different opposing sides as the first and second arms 122. The third and fourth arms 123 can be shorter than the first and second arms 122. The arms 122, 123 can be defined by the non-metallic substrate and be devoid of metal so as to be non-conductive.

The front planar surfaces 122f, 123f of the arms 122, 123 can be co-planar with the front primary surfaces 112f of the radiating elements 112 as shown but may also be parallel to and recessed or extend in a plane that is forward of the front primary surface 112f of the radiating elements 112. The first and second arms 122 can have a rear surface 122r and/or the third and fourth arms 123 can have a rear surface 123r that extends behind the front primary surface 112f of the radiating elements and/or a front end 120f of the horizontal or vertical wall 120h, 120v, respectively. The rear surfaces 122r, 123r of one or both sets of the arms 122, 123 can be co-planar with the rear primary surface 112r of the radiating elements 112. The rear-surfaces can be parallel to the rear primary surface 112r of the radiating elements 112 but reside forward or rearward of the rear primary surface 112r.

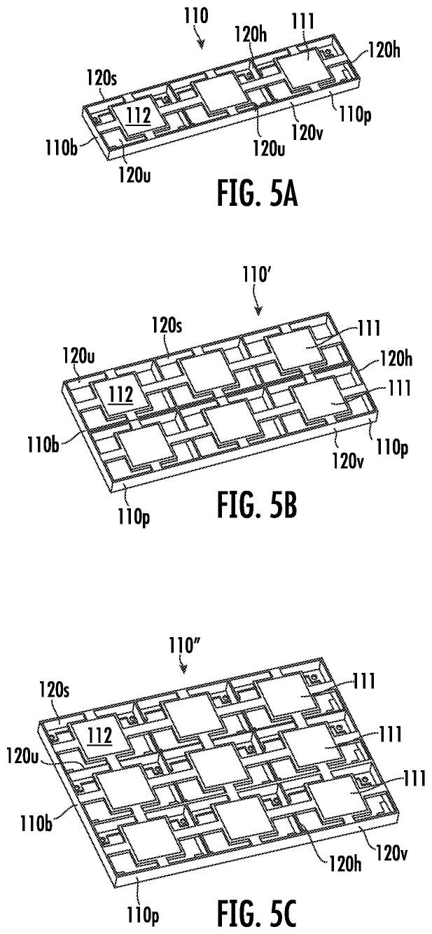

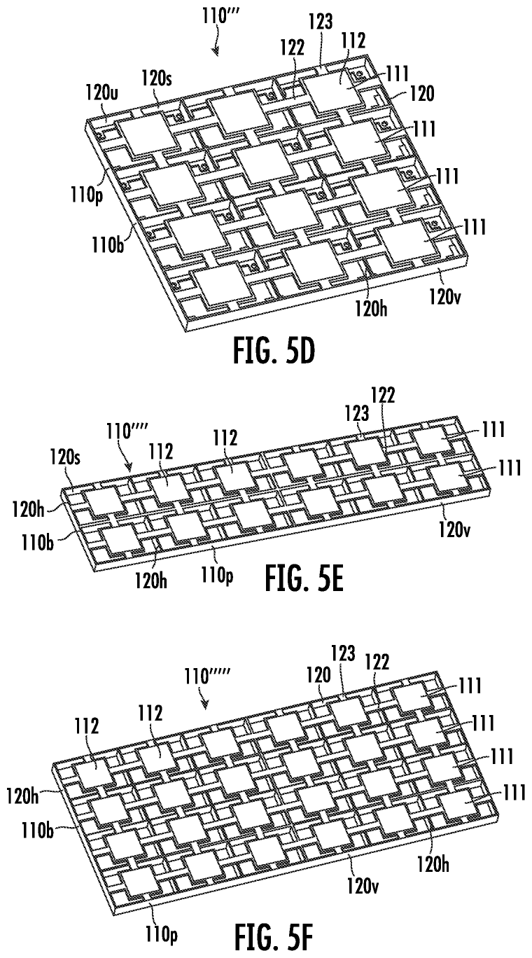

In the example embodiment shown in FIGS. 2, 3A, 3B, there are four antenna modules 110₁-110₄ that each provide a subset of (e.g., three) radiating elements 112 to cumulatively define one linear array 111 of radiating elements 112, However, as shown in FIGS. 5A-5F, the antenna modules 110 can have other configurations and may, for example, include a plurality of rows and/or a plurality of columns of radiating elements 112. The antenna modules 110 can also be configured to provide fence grid segments 120s comprising a plurality of fence units 120u of the fence grid 120. The antenna module 110 can have an outer perimeter 110p that defines some of the vertical walls 120v and some of the horizontal walls 120h of some of the grid units 120u.

In some embodiments, to assemble a respective antenna module 110, the printed circuit board 135 can be slid behind the radiating elements 112 to couple to laterally inwardly extending rims 110r of the antenna module 110 and/or to an underlying structure such as the reflector 115.

Each antenna module 110 can include apertures 117 for receiving fasteners 117f to couple adjacent antenna modules 110 to each other and/or to an underlying structure, such as a reflector 115, in some embodiments. The apertures 117 can be provided at end portions or end corners as shown in FIGS. 3B, 4A, 4B.

Referring to FIG. 4B, the body 110b of the antenna module 110 can define rearwardly extending standoffs 127 that can extend rearwardly further than the feed columns 130. The standoffs 127 may be configured to facilitate attachment or placement relative to the reflector and/or ground plane behind the antenna module 110.

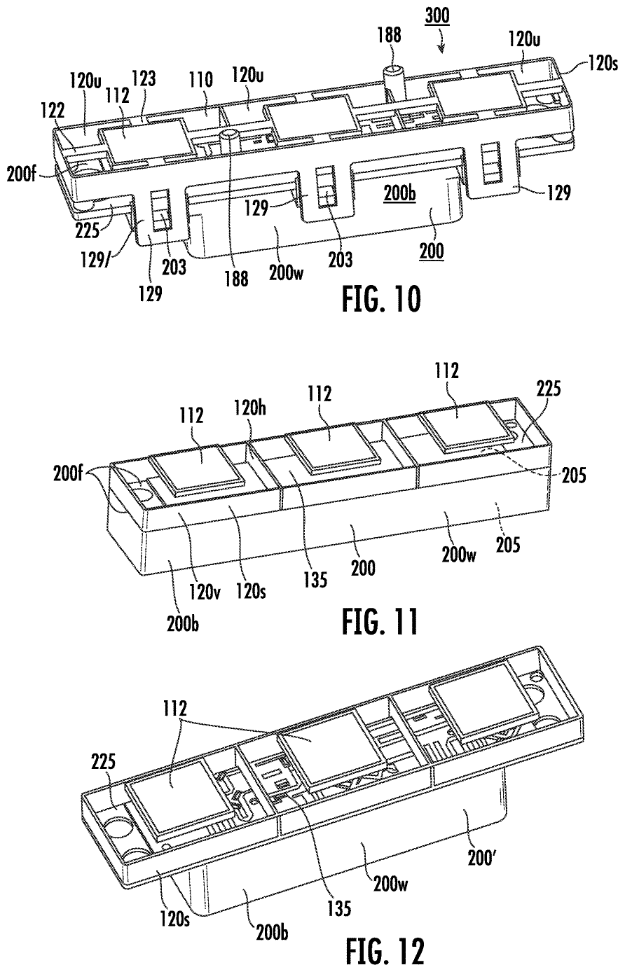

FIG. 10 illustrates that radome (non-conductive) supports 188 that extend forward of the fence grid 120 and/or radiating elements 112 may also be provided by the antenna module 110.

Referring to FIGS. 5A-5F, the body 110b of the antenna module 110 can be a unitary monolithic injection molded body that also provides a fence grid segment 120s or the entire fence grid 120, in some embodiments.

Referring to FIGS. 7A and 7B, in some embodiments, the antenna module 110 can be provided by a first body portion 110bi that provides one or more of the radiating antenna elements 112 and a second cooperating body portion 110b2 that provides the fence grid 120 or a fence grid segment 120s. Where the fence grid 120 or fence grid segment 120s is provided as a separate body, the entire fence grid 120 or fence grid segment 120s can be coated which can reduce production costs. Similarly, the structure defining the feed columns 130 and planar radiating element member 112 can be coated/sprayed/dipped to reduce fabrication costs.

FIG. 5A illustrates that the antenna module 110 provides a 1×3 array configuration of radiating elements 112 with a fence grid segment 120s. The body 110b of the antenna module 110 has a rectangular outer perimeter 110p and defines some horizontal walls 120h and some vertical walls 120v of respective grid units 120u. The antenna module 110 can be assembled so that the radiating elements 112 define a portion of a column of a respective linear array 111. If so, the long side of the outer perimeter 110p is oriented to define a vertical wall 120v. It is noted that the antenna module 110 can be assembled so that the radiating elements 112 define a radiating element of adjacent different linear arrays 111 (e.g., laterally rather than longitudinally). The vertical fence walls 120v will then be horizontal fence walls 120h and vice versa.

FIG. 5B illustrates that the antenna module 110′ provides a 2×3 array configuration of radiating elements 112 with a fence grid segment 120s. The body 110b of the antenna module 110 has a rectangular outer perimeter 110p and defines some horizontal walls 120h and some vertical walls 120v of respective grid units 120u. Different columns or rows of the radiating elements 112 can have different fence grid configurations. It is noted that the antenna module 110 can be assembled so that the radiating elements 112 define a radiating element of adjacent different linear arrays 111 (e.g., laterally rather than longitudinally). The vertical fence walls 120v will then be horizontal fence walls 120h and vice versa.

FIG. 5C illustrates that the antenna module 110″ provides a 3×3 array configuration of radiating elements 112 with a fence grid segment 120s. The body 110b of the antenna module 110 has a rectangular outer perimeter 110p and defines some horizontal walls 120h and some vertical walls 120v of respective grid units 120u. It is noted that the antenna module 110 can be assembled so that the radiating elements 112 define a radiating element of adjacent different linear arrays 111 (e.g., laterally rather than longitudinally). The vertical fence walls 120v will then be horizontal fence walls 120h and vice versa.

FIG. 5D illustrates that the antenna module 110″′ provides a 4×3 array configuration of radiating elements 112 with a fence grid segment 120s. The body 110b of the antenna module 110 has a rectangular outer perimeter 110p and defines some horizontal walls 120h and some vertical walls 120v of respective grid units 120u. It is noted that the antenna module 110 can be assembled so that the radiating elements 112 define a radiating element of adjacent different linear arrays 111 (e.g., laterally rather than longitudinally). The vertical fence walls 120v will then be horizontal fence walls 120h and vice versa.

FIG. 5E illustrates that the antenna module 110″″ provides a 2×6 array configuration of radiating elements 112 with a fence grid segment 120s. The body 110b of the antenna module 110 has a rectangular outer perimeter 110p and defines some horizontal walls 120h and some vertical walls 120v of respective grid units 120u. It is noted that the antenna module 110 can be assembled so that the radiating elements 112 define a radiating element of adjacent different linear arrays 111 (e.g., laterally rather than longitudinally). The vertical fence walls 120v will then be horizontal fence walls 120h and vice versa.

FIG. 5F illustrates that the antenna module 110″′″ provides a 4×6 array configuration of radiating elements 112 with a fence grid segment 120s. The body 110b of the antenna module 110 has a rectangular outer perimeter 110p and defines some horizontal walls 120h and some vertical walls 120v of respective grid units 120u. It is noted that the antenna module 110 can be assembled so that the radiating elements 112 define a radiating element of adjacent different linear arrays 111 (e.g., laterally rather than longitudinally). The vertical fence walls 120v will then be horizontal fence walls 120h and vice versa.

It will be appreciated that the different array configurations are shown by way of example and other array configurations may be used.

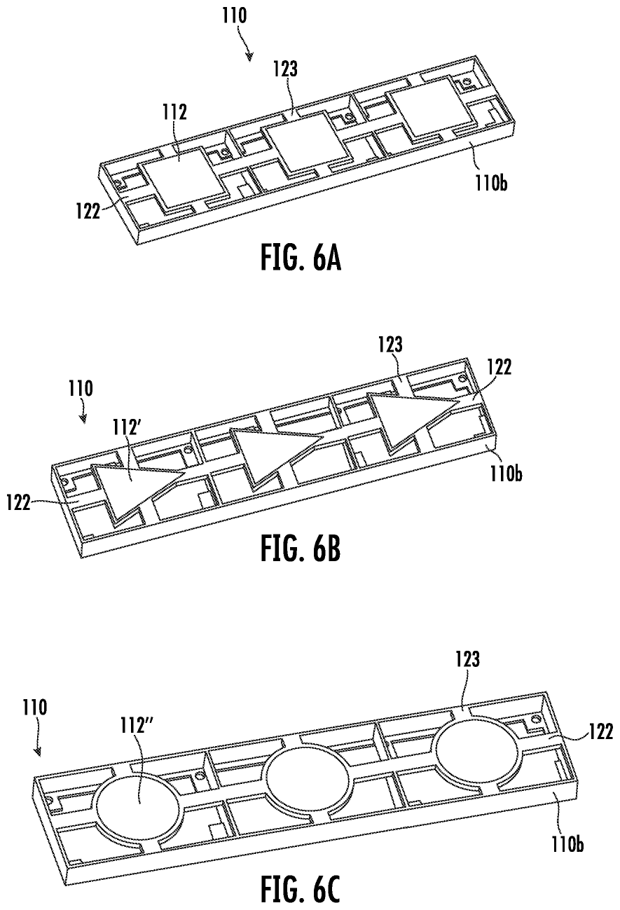

FIGS. 6A-6C illustrate that the radiating elements 112, 112′, 112″ can have different configurations. As shown, the radiating elements 112, 112′, 112″ are patch radiating elements. FIG. 6A illustrates a planar polygonal (square) configuration. FIG. 6B illustrates a triangular configuration. FIG. 6C illustrates a circular configuration. These shapes are by way of example only and other shapes may be used, including, but not limited to, rectangular, pentagonal, hexagonal, octagonal and the like.

The front surface 112f of the patch (radiating element) 112 has a metal outer surface (the metal can extend continuously across at least 70%, typically an entire, outer front surface) and the rear surface 112r has a metallized pattern on only a portion thereof.

Referring again to FIG. 7B, the feed columns 130 can be provided as a plurality of columns, shown as four, that provide the electrical coupling between the feed board 135 and the metal patches of radiating elements 112. The plurality of spaced apart metallized regions 110r can be provided as four spaced apart regions, optionally with a remainder of the rear surface being non-metallized. The plurality of feed columns 130 can be provided as four feed columns, one feed column 130 being electrically coupled to a corresponding one metallized region 110r. Each feed column 130 can carry a signal trace for the RF signal.

Two feed columns 130 for a respective radiating element 112 can define two feeding paths, one for each polarization.

The feed board 135 can comprise a power divider circuit that splits the signal into sub-components, e.g., three sub-components to three radiating elements 112, or the number of radiating elements 112 provided by an antenna module 110. No ground connection is required for the patch 112 to/from the feed board 135.

The metallized regions 110r can be configured as two circular regions connected by a straight linear region. The metallized regions 110r are spaced apart from each other and may extend at an angle of about 45 degrees, starting at a location spaced apart from a common center point and in a direction toward each outer perimeter (corner) of the planar radiating element 112.

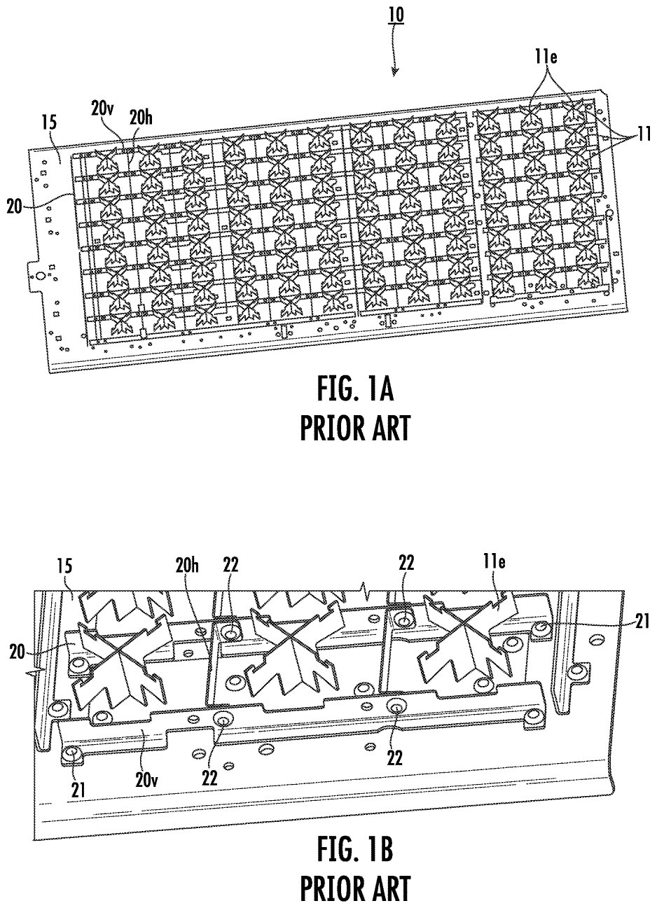

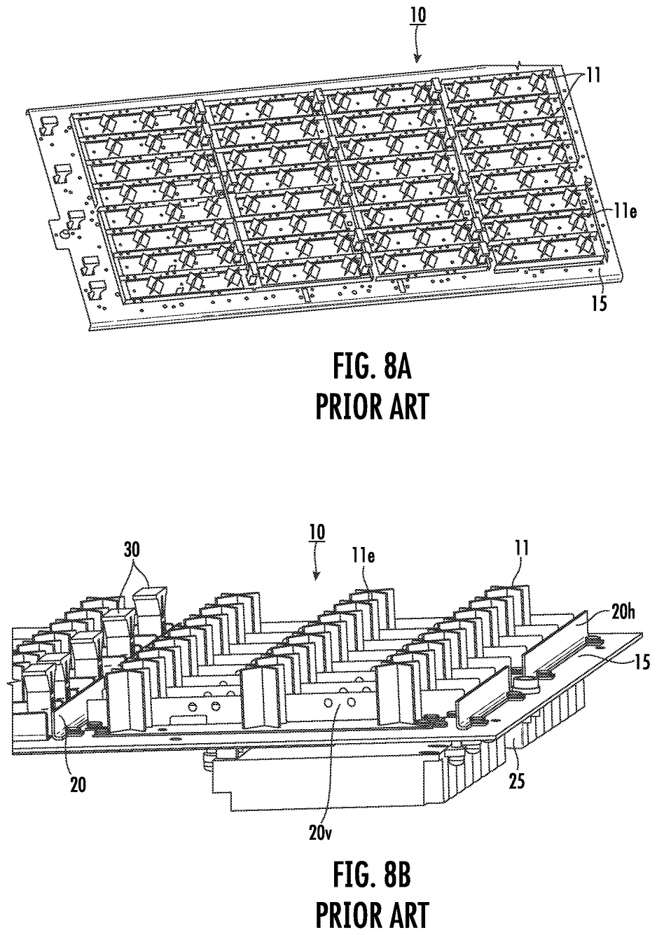

Turning now to FIGS. 8A and 8B, an example prior art antenna 10, similar to that shown in FIG. 1A, is shown attached to a filter unit 25 and also including non-conductive radome support members 30. As discussed above with respect to FIGS. 1A, 1B, there are many parts that are assembled together that can result in relatively high cost for material and labor.

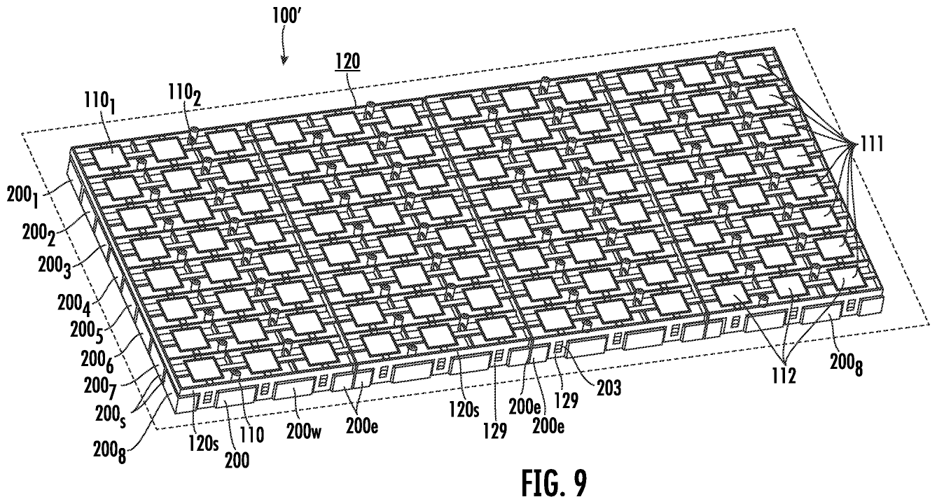

Referring to FIGS. 9 and 10, the base station antenna 100′ can be configured to include a bank of filter units 200. The bank of filter units 200 can be arranged in rows and columns, with the rows and columns of filter units 200 aligned with the linear arrays 111. In some embodiments, one filter unit 200 is coupled to one antenna module 110 to define a filter and antenna assembly unit 300 (FIG. 10).

Thus, as shown, a first antenna module 110₁ is coupled to a first filter unit 200₁ and a second antenna module 110₂ is coupled to a second filter unit 200₂. The first filter unit 200₁ resides behind the first antenna module 110₁ and the second filter unit 200₂ resides behind the second antenna module 110₂.

In the embodiment shown in FIG. 9, there are an equal number of antenna modules 110 and filter units 200 defining the number of filter and assembly units 300.

However, one filter unit 200 may be coupled to more than one antenna module 110. As also shown, there are eight columns of filter units 200₁-200₈, and four filter units 200 arranged longitudinally along each column, with one filter unit 200 behind every three radiating elements 112, for a total of 32 filter units 200 in the embodiment shown, by way of example. It will be appreciated that other configurations can be used. For example, the filter units 200 can be provided as one extending longitudinally per column, or one per linear array 111, or a plurality per column/linear array 111 as shown. It will also be appreciated that in other embodiments multiple filter units 200 may be coupled to each antenna module 110, particularly when antenna modules 110 having a large number of radiating elements 112 are used.

Ends 200e of adjacent filter units 200 in each column can be closely spaced apart or may abut each other. Outer (long) side perimeters 200w of adjacent filter units 200 in neighboring columns can also be closely spaced apart or abut each other.

The filter units 200 can have side walls 200w that are metallic.

In some embodiment, the neighboring filter units 200 are capacitively or galvanically coupled to provide a common ground plane with minimal RF leakage from any gaps between the neighboring filter units 200.

Neighboring filter units 200 can be capacitively coupled, e.g., long sides 200s and short sides/ends 200e of some, or all, of the neighboring filter units 200 can be adjacently positioned and capacitively coupled.

Neighboring fence grid segments 120s of neighboring (first and second neighboring bodies of) antenna modules 110 can be configured so that outer fence walls facing each other are also or alternatively capacitively coupled.

The filter units 200 can have metal side walls 200w that electrically couple to the fence grid 120.

Each antenna module 110 can be configured with a fence grid segment 120s that comprises a plurality of fence units 120u. At least some of the fence grid segment 120s comprises an outer perimeter 120p with rearwardly extending fastener segments 129 that attach to a corresponding filter unit 200 such as via a “snap-fit” configuration. The fastener segments 129 can be configured with rearwardly extending legs 129/that cooperate with projections 203 of the filter unit 200 to thereby attach without requiring rivets or screws.

Other attachment configurations may be used, including providing the leg 129/on the filter unit 200 and the projection on the antenna module 110. The leg 129/can be configured to frictionally engage the corresponding projection 203 so that no rivet, screw or pin is required to assemble the filter unit 200 to the antenna module 110. The fastener segments 129 may be metallized and may capacitively couple with the corresponding filter units 200.

FIGS. 11 and 12 illustrate that the filter unit 200′ can provide part of all of the fence grid segment 120s. The fence grid segment 120s provided by the filter unit 200′ can be metal.

FIG. 11 also shows that the filter unit 200 can include a metal cover 225 over a cavity 205 enclosing filter components such as resonators 275. The cover 225 can define a reflector segment for the base station antenna. Thus, the bank of filter units 200, 200′ cooperate to define a reflector providing the ground plane and formed of corresponding reflector segments provided by the metal covers 225. The metal cover 225 can be sheet metal and/or diecast, in some embodiments.

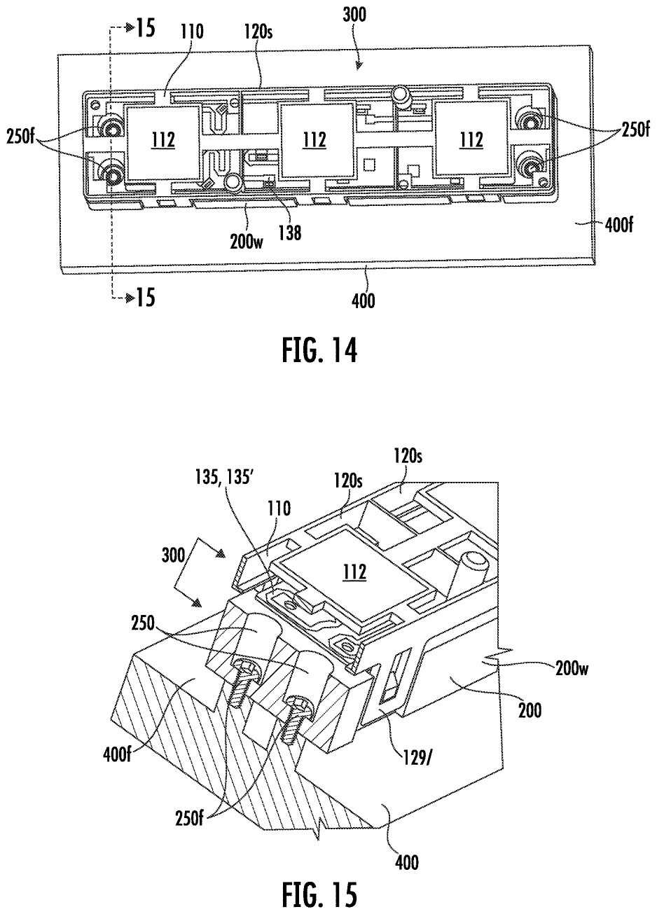

Referring to FIGS. 9-12, the filter units 200, 200′ can provide the printed circuit boards 135 providing the feed network 138 (FIG. 14) for the radiating elements 112.

The filter unit 200, 200′ can have a front 200f that merges into a rearwardly extending primary body 200b. The primary body 200b can provide a cavity 205 that encloses filter components such as resonators 275. The primary body 200b can have a length that is the same as the front 200f (FIG. 11) or that is shorter than the front 200f. The primary body 200b can be longer than the printed circuit board 135 (FIG. 11) or shorter than the printed circuit board 135 (FIGS. 10, 12).

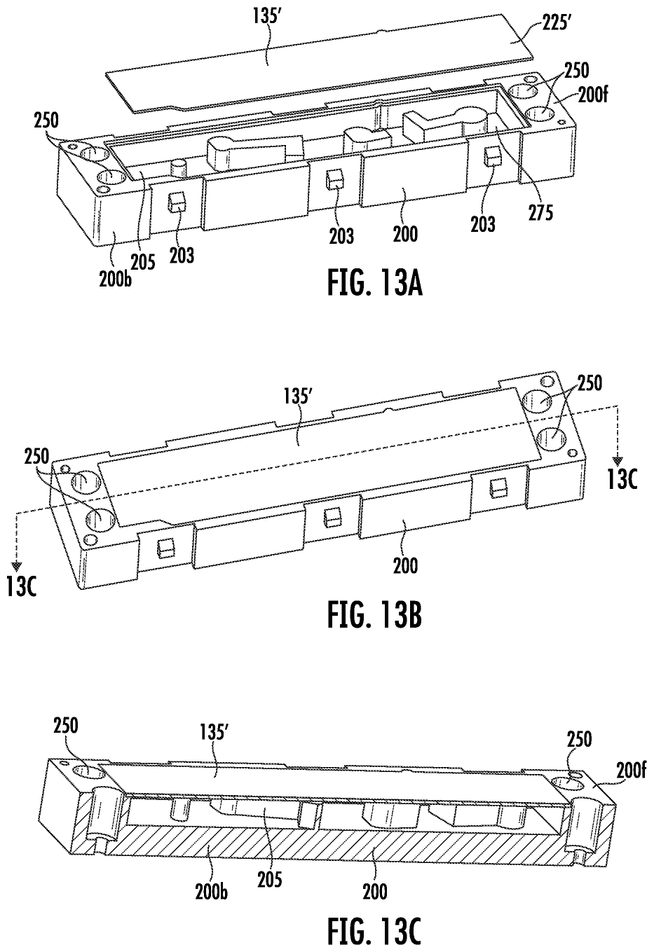

Referring to FIGS. 13A-13C, the printed circuit board 135′can define a cover for the filter unit 200 and no metal cover is required. Instead, the printed circuit board 135′ can reside in front of the cavity 205 with the filter components such as resonators 275 to define the cover and provide a ground plane for the radiating elements 112. The ends 135e of the printed circuit board 135 can align with ends/corners of the fence grid segment 120s.

Thus, the filter units 200 can be devoid of a front metal cover and can be configured so that a ground plane on a back side of a respective feed board 135′ directly contacts a front surface 200f of a corresponding filter unit 200.

The printed circuit board 135′ can be longer than the printed circuit board 135 used with a metal cover 235.

Solder pads can be provided on top of the feed board 135 and can be used to connect the fence grid 120 or segments 120s at the corners.

In some embodiments, the resonators 275 can cooperate with two ground planes, one of the two ground planes can be provided by the feed board PCB 135, the other one can be a metal sheet or metal frame with bendable tuning elements (e.g., spirals or tabs).

Referring to FIGS. 14 and 15, the filter unit 200 can include rearwardly extending coupling channels 250 that receive coupling fasteners 250f that couple a radio module 400 that resides behind and coupled to the filter unit 200. A front surface 400f of the radio module 400 can be configured to provide an RF shield in some embodiments.

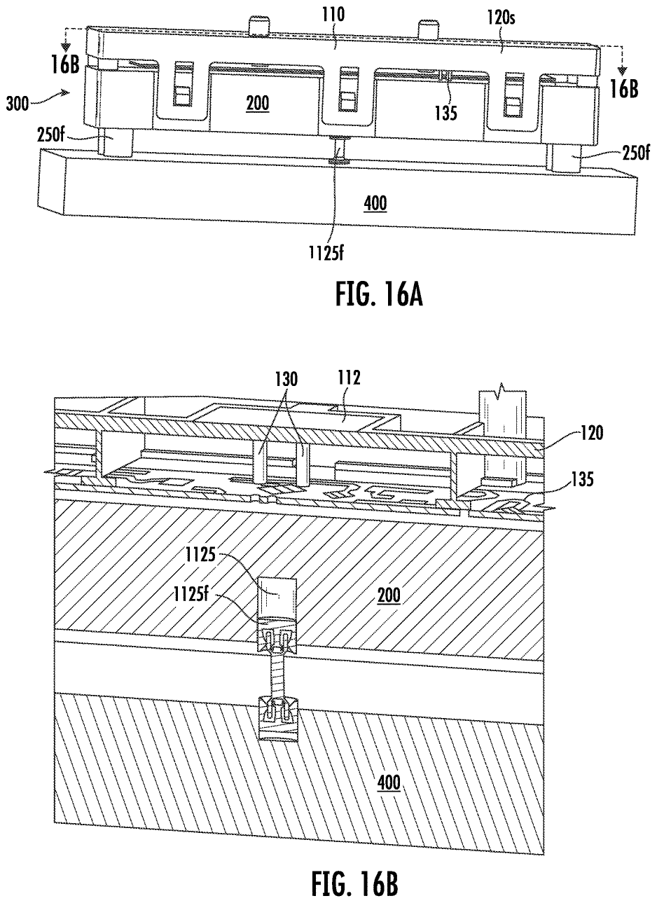

FIGS. 16A and 16B illustrate that the filter unit 200 can further comprise an additional fastener coupling channel 1125 and fastener 1125f between the fasteners 250f and channels 250 residing on opposing end portions of the filter unit 200. One or more of the fasteners 250f, 1125f can provide an electrical coupling as well as a mechanical coupling to the radio unit 400.

In some embodiments, the fastener 1125f can be a pogo pin connector assembly that cooperates with walls of the filter unit 200 to that define an internal chamber comprising an RF transmission line structure. In such embodiments, the pogo pin connector assembly 1125f may comprise an inner conductor of the RF transmission line structure and the walls that define the internal chamber of the cavity 205 may comprise part of an outer conductor or ground of the RF transmission line structure. For example, the filter units 200 may include pogo-pin connector assemblies 1125f that, for downlink signals, connect a filter of the filter unit 200 to a first external circuit (e.g., a radio) that generates the RF signals that are input to the filter and/or to a second external circuit (e.g., one or more radiating elements) that receives the RF signals output by the filter. For uplink signals, the pogo-pin connector assemblies 1125f may receive RF signals from the second external circuit and pass them to the filter and/or may pass the uplink signals from the filter to the first external circuit. The use of such pogo-pin connector assemblies (or other spring-biased contacts) 1125f may significantly simplify the manufacturing process, as forming soldered connections is a labor-intensive operation. However, embodiments of the present invention do not exclude the use of soldered or other connections between the radio 400 and filter units 200.

In some embodiments, the filter unit 200 with the printed circuit board 135 can be configured to include a resonant cavity filter that includes a metal housing having an opening therein and a contact (e.g., a spring-biased contact) that extends through the opening in the metal housing to contact a port of the resonant cavity filter.

The radio module 400 can be configured as a 5G module in some embodiments. With the introduction of fifth generation (“5G”) cellular technologies, base station antennas are now routinely being deployed that have active beamforming capabilities. Active beamforming refers to transmitting RF signals through a multi-column array of radiating elements in which the relative amplitudes and phases of the sub-components of an RF signal that are transmitted (or received) through the different radiating elements of the array are adjusted so that the radiation patterns that are formed by the individual radiating elements constructively combine in one or more desired directions to form narrower antenna beams that have higher gain. With active beamforming, the shape and pointing direction of the antenna beams generated by the multi-column array may, for example, be changed on a time slot-by-time slot basis of a time division duplex (“TDD”) multiple access scheme.

Moreover, different antenna beams can be generated simultaneously on the same frequency resource in a multi-user MIMO scenario. More sophisticated active beamforming schemes can apply different beams to different physical resource blocks that are a combination of time and frequency resources by applying the beam vector in the digital domain. Base station antennas that have active beamforming capabilities are often referred to as active antennas.

When the multi-column array includes a large number of columns of radiating elements (e.g., sixteen or more), the array is often referred to as a massive MIMO array. A module that includes a multi-column array of radiating elements and associated RF circuitry (and perhaps baseband circuitry) that implement an active antenna is referred to herein as an active antenna module. Active antenna modules may be deployed as standalone base station antennas or may be deployed in larger antenna structures that include additional active antenna modules and/or conventional “passive” antenna arrays that are connected to radios that are external to the antenna structures.

The linear arrays 111 can be provided as low, mid or high band radiating elements 112. Typically, the linear arrays will include mid-band or high-band radiating elements. When high-band radiating elements are used, they may be configured to transmit and receive signals in a first frequency band. In some embodiments, the first frequency band may be the 3.3-4.2 GHz frequency band or a portion thereof. In other embodiments, the first frequency band may be the 5.1-5.8 GHz frequency band or a portion thereof. When mid-band radiating elements are used, the first frequency band may be, for example, the 1.695-2.690 GHz frequency band or a portion thereof.

It will be appreciated that other types of radiating elements may be used, that more or fewer linear arrays may be included in the antenna, that the number of radiating elements per array may be varied, and that planar arrays or staggered linear arrays may be used instead of the “straight” linear arrays illustrated in the figures in other embodiments.

In some embodiments, the printed circuit board 135 or metal cover 225 can be replaced or include a frequency selective surface or surfaces (“FSS”). See, e.g., Ben A.

Munk, Frequency Selective Surfaces: Theory and Design, ISBN: 978-0-471-37047-5; DOI: 10.1002/0471723770; April 2000, Copyright @ 2000 John Wiley & Sons, Inc. the contents of which are hereby incorporated by reference as if recited in full herein.

As discussed above, the base station antenna 100 can include one or more arrays of low-band radiating elements, one or more arrays of mid-band radiating elements, and one or more arrays of high-band radiating elements. The radiating elements may each be dual-polarized radiating elements. Further details of radiating elements can be found in co-pending WO2019/236203 and WO2020/072880, the contents of which are hereby incorporated by reference as if recited in full herein.

It will also be appreciated that the number of linear arrays of low-band, mid-band and high-band radiating elements may be varied from what is shown in the figures. For example, the number of linear arrays of each type of radiating elements may be varied from what is shown, some types of linear arrays may be omitted and/or other types of arrays may be added, the number of radiating elements per array may be varied from what is shown, and/or the arrays may be arranged differently.

Embodiments of the present invention have been described above with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

In the discussion above, reference is made to the linear arrays of radiating elements that are commonly included in base station antennas. It will be appreciated that herein the term “linear array” is used broadly to encompass both arrays of radiating elements that include a single column of radiating elements that are configured to transmit the sub-components of an RF signal as well as to two-dimensional arrays of radiating elements (i.e., multiple linear arrays) that are configured to transmit the sub-components of an RF signal. It will also be appreciated that in some cases the radiating elements may not be disposed along a single line. For example, in some cases a linear array of radiating elements may include one or more radiating elements that are offset from a line along which the remainder of the radiating elements are aligned. This “staggering” of the radiating elements may be done to design the array to have a desired azimuth beamwidth. Such staggered arrays of radiating elements that are configured to transmit the sub-components of an RF signal are encompassed by the term “linear array” as used herein.

As used herein, “monolithic” means an object that is a single, unitary piece formed or composed of a material.

It will be understood that, although the terms first, second, etc. may be used herein to describe various elements, these elements should not be limited by these terms.

These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “on” another element, it can be directly on the other element or intervening elements may also be present. In contrast, when an element is referred to as being “directly on” another element, there are no intervening elements present. It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between”, “adjacent” versus “directly adjacent”, etc.).

The term “about” with respect to a number, means that the stated number can vary by +/−20%.

Relative terms such as “below” or “above” or “upper” or “lower” or “horizontal” or “vertical” may be used herein to describe a relationship of one element, layer or region to another element, layer or region as illustrated in the figures. It will be understood that these terms are intended to encompass different orientations of the device in addition to the orientation depicted in the figures.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” “comprising,” “includes” and/or “including” when used herein, specify the presence of stated features, operations, elements, and/or components, but do not preclude the presence or addition of one or more other features, operations, elements, components, and/or groups thereof.

Aspects and elements of all of the embodiments disclosed above can be combined in any way and/or combination with aspects or elements of other embodiments to provide a plurality of additional embodiments.

1. A base station antenna, comprising:
a plurality of radiating elements, wherein each radiating element comprises a non-metallic substrate and metal on defined surfaces of the non-metallic substrate; and
a fence grid comprising a plurality of fence units, wherein one fence unit comprises a pair of horizontal walls and a pair of vertical walls that extend about one radiating element of the plurality of radiating elements.

2. (canceled)

3. The base station antenna of claim 1, wherein the fence grid comprises a non-metallic substrate and metal on at least one outer surface thereof.

4. The base station antenna of claim 3, further comprising a longitudinally or laterally extending arm extending between a pair of adjacent radiating elements, and a laterally extending or longitudinally extending arm extending between a vertical and/or horizontal wall of the fence unit extending about respective radiating elements of the pair of adjacent radiating elements.

5. The base station antenna of claim 1, wherein the plurality of radiating elements are provided as an antenna module comprising a hollow non-metallic body with a rectangular perimeter that provides a subset of radiating elements of a linear array of radiating elements.

6. (canceled)

7. The base station antenna of claim 6, further comprising a plurality of feed columns that extend in a rearward direction behind the rear primary surface and comprise a non-metal substrate with an outer surface with metal thereon.

8. The base station antenna of claim 7, wherein the radiating elements are provided as patch radiating elements, wherein the plurality of spaced apart metallized regions are provided as four spaced apart regions, optionally with a remainder of the rear surface being non-metallized, and wherein the plurality of feed columns are provided as four feed columns for providing RF signal paths, one feed column being electrically coupled to a corresponding one metallized region.

9. (canceled)

10. The base station antenna of claim 9, wherein the first body comprises a first fence grid segment integral thereto or attached thereto and with a plurality of fence units forming part of the fence grid, and wherein the second body comprises a second fence grid segment integral thereto or attached thereto with a plurality of fence units forming part of the fence grid.

11. (canceled)

12. The base station antenna of claim 1, wherein the plurality of radiating elements and the fence grid are provided as a unitary body, wherein the unitary body further comprises laterally and longitudinally extending arms that extend between vertical and/or horizontal walls of the fence grid and adjacent radiating elements, and wherein either the laterally extending arms have a greater length than the longitudinally extending arms or the longitudinally extending arms have a greater length than the laterally extending arms.

13. (canceled)

14. The base station antenna of claim 7, further comprising a printed circuit board residing behind the feed columns that extend in a rearward direction, wherein the printed circuit board is configured to define a feed network that is coupled to the feed columns.

15. The base station antenna of claim 1, further comprising a filter unit behind the plurality of radiating elements, coupled to a body of an antenna module providing the plurality of radiating elements, wherein the body of the antenna module provides the plurality of radiating elements as a subset of a linear array of radiating elements or a single linear array of radiating elements of the base station antenna.

16. The base station antenna of claim 15, wherein the plurality of radiating elements are a first plurality of radiating elements provided by a first antenna module, wherein the base station antenna comprises a second plurality of radiating elements provided by a second antenna module, wherein the filter unit is a first filter unit, wherein the base station antenna further comprises a second filter unit, and wherein the first filter unit resides behind the first antenna module and the second filter unit resides behind the second antenna module.

17. The base station antenna of claim 16, wherein the fence grid comprises a first fence grid segment comprising a plurality of fence units and a second fence grid segment comprising a plurality of fence units, wherein each of the first and second grid segments comprises an outer perimeter with rearwardly extending fastener segments, and wherein the fastener segments of the first fence grid segment attaches to the first filter unit and the fastener segments of the second fence grid segment attaches to the second filter unit.

18. The base station antenna of claim 17, wherein the fastener segments comprise rearwardly extending legs that cooperate with projections of the filter unit to thereby attach without requiring rivets or screws.

19. The base station antenna of claim 16, wherein the first filter unit and the second filter unit are adjacently positioned and capacitively coupled.

20. The base station antenna of claim 16, wherein each of the first and second filter units comprises a cavity with an elongate printed circuit board residing in front of the cavity to define a cover for the cavity and to provide a ground plane.

21. The base station antenna of claim 16, wherein each of the first and second filter units comprises a cavity with a metal cover residing in front of the cavity and defining a ground plane.

22. The base station antenna of claim 15, further comprising a radio module behind and coupled to the filter unit.

23. The base station antenna of claim 16, wherein the first fence grid segment is provided by a first body and the second fence grid segment is provided by a second separate body, and wherein outer fence walls of the first and second bodies are capacitively coupled.

24. The base station antenna of claim 15, wherein the filter unit comprises metal side walls that electrically couple to the fence grid.

25. The base station of claim 20, wherein the first and second filter units are devoid of a front metal cover and are configured so that a ground plane on a back side of a respective feed board directly contacts a front surface of a corresponding filter unit.

26. A base station antenna, comprising:
a plurality of filter units that are arranged in columns and rows; and
a plurality of antenna modules, each comprising one or more linear arrays of radiating elements, coupled to and arranged in front of the plurality of filter units, optionally wherein the filter units define a ground plane for the plurality of linear arrays of radiating elements and act as a reflector for the linear arrays of radiating elements.

27-36. (canceled)

37. A base station antenna, comprising:
a plurality of antenna modules that are adjacently positioned and spaced apart in columns and rows or columns or rows across a width and a longitudinal length of the base station antenna, wherein each of the plurality of antenna modules comprise a body formed of a non-metallic substrate that provides a plurality of spaced apart planar members at a front thereof, wherein each of the planar members have a primary front surface and an opposing primary rear surface defining radiating elements, wherein the front surface comprises a metal outer surface and the rear surface comprises a metallized pattern on only a portion thereof.

38-40. (canceled)
